(19) United States
(12) Patent Application Publication
(10) Pub. No.: US 2008/0317124 A1
(43) Pub. Date: Dec. 25, 2008

(54) MULTI-VIEW VIDEO CODING SYSTEM, DECODING SYSTEM, BITSTREAM EXTRACTION SYSTEM FOR DECODING BASE VIEW AND SUPPORTING VIEW RANDOM ACCESS

(76) Inventors: Sukhee CHO, Daejeon (KR); Namho HUR, Daejeon (KR); Jin Woong KIM, Daejeon (KR); Soo In LEE, Daejeon (KR); Yung-Lyul LEE, Seoul (KR); Sung-Chang LIM, Seoul (KR)

Correspondence Address: LADAS & PARRY LLP, 224 SOUTH MICHIGAN AVENUE, SUITE 1600, CHICAGO, IL, 60604, US

(21) Appl. No.: 12/142,863

(22) Filed: Jun. 20, 2008

Related U.S. Application Data
(60) Provisional application No. 60/945,965, filed on Jun. 25, 2007.

(30) Foreign Application Priority Data
Apr. 29, 2008 (KR) 10-2008-0040079

(51) Int. Cl. H04N 11/02

(52) U.S. Cl. 375/240.08; 375/E07.076

(57) ABSTRACT

A multi-view video coding (MVC) system, a decoding system, and a bitstream extraction system are provided for decoding a base view and supporting a view random access. The MVC system includes: a coding unit that codes the video signal to a base view and a multi-view; and a base view identifier adding unit that adds a base view identifier of the base view to a parameter set.

### CROSS-REFERENCE TO RELATED APPLICATIONS

This application claims priorities from U.S. Provisional Application No. 60/945,965, filed on Jun. 25, 2007, in the U.S. Patent and Trademark Office, and Korean Patent Application No. 10-2008-0040079, filed on Apr. 29, 2008, in the Korean Intellectual Property Office, the entire disclosures of which are incorporated herein by reference.

### BACKGROUND OF THE INVENTION

1. Field of the Invention

The present invention relates to a multi-view video coding system, a decoding system, a bitstream extraction system for decoding a base view and supporting a view random access.

This work was supported by the IT R&D program of MIC/IITA [2007-S-004-01, The Development of an autostereoscopic three-dimensional (3D) personalized broadcasting technique].

2. Description of Related Art

In multi-view video coding (MVC), a multi-view video providing a user with a more realistic three-dimensional (3D) effect is a new technology field that provides the user with multi-view images in multiple directions by geometrically correcting images having a picture taken via at least two cameras. The multi-view video has advantages in that the user may freely select a viewpoint when viewing the image and feel a 3D effect via a wide screen. However, in the multi-view video, a method for effectively processing data is required since an amount of data required increases as a number of views are increased.

In definition of requirements in standardization of multi-view video coding (MVC) under construction in a moving picture experts group (MPEG) and joint video team (JVT), backwards compatible technology is prescribed to decode a base view in a decoder of a conventional advance video coding.

That is, in a predetermined time axis, a bitstream corresponding to a single view should be based on the advanced video coding. In other words, from among images of an N number of views which is coded in a multi-view video encoder, a user having a conventional device can share contents of the multi view video by allowing an image of a single view to be decoded via the advanced video coding.

Also, a view random access is disclosed. Specifically, the MVC should support a view random access. As an example, it should be possible to access a frame in a required view through minimal decoding of a frame in other views. Such view random access is required to smoothly provide a user with contents by allowing the user to access an image of a predetermined view in a desired time span in a short time according to a user's need.

### SUMMARY OF THE INVENTION

An aspect of the present invention provides a multi-view video coding (MVC) system that allows a decoder to decode an image, which is coded from an MVC to a base view for backward compatibility in a conventional advanced video coding (AVC).

Another aspect of the present invention also provides a MVC system that can support an application having a plurality of views that should be independently decoded by separately defining an independent view being coded without referring to other views, and can easily support a view random access.

According to an embodiment of the present invention, there is provided a MVC system including: a coding unit that codes the video signal to a base view and a multi-view; and a base view identifier adding unit that adds a base view identifier of the base view to a parameter set. In this instance, the base view may be limited to a single view of all views.

In an aspect of the present invention, the parameter set may be transmitted to a decoding system prior to the coded video signal. In this instance, the coded video signal being coded to the base view may be verified in the decoding system based on a base view identifier of a previously parameter set.

In an aspect of the present invention, the parameter set may be included in a network abstraction layer (NAL) being transmitted prior to an NAL of a video signal which is actually coded when transmitting the coded video signal.

In an aspect of the present invention, the coding unit may further code the video signal to an independent view, and further comprises an independent view flag adding unit adding the independent view flag of the independent view to a header of an NAL unit. In this instance, the video signal being coded to the independent view may be coded without referring to other views, and the independent view flag may indicate whether the video signal corresponding to the NAL unit is an independent view.

In an aspect of the present invention, the MVC system may further include: a bitstream generation unit that generates a bitstream including at least two of a first NAL with respect to the parameter set and a second NAL with respect to the coded video signal. The first NAL is transmitted to prior to the second NAL.

According to an embodiment of the present invention, there is provided a decoding system including: a bitstream receiving unit that receives a bitstream of the coded video signal; and a decoding unit that decodes a bitstream corresponding to a base view based on a parameter set included in the received bitstream.

According to an embodiment of the present invention, there is provided a bitstream extraction system including: a receiving unit that receives a bitstream from a multi-view video coding system; a bitstream extraction unit that extracts at least one portion of the bitstream based on at least one of a parameter set and a header of a NAL unit; and a transmission unit that transmits the extracted at least one portion of the bitstream.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating an application system in which a bitstream being coded through multi-view video coding (MVC) is inputted to a decoder as a single bitstream according to an exemplary embodiment of the present invention;

FIG. 2 is a diagram illustrating a coded slice unit according to an exemplary embodiment of the present invention;

FIG. 3 is a diagram illustrating an application system in which a bitstream being coded through MVC is inputted to a decoder as a bitstream whose necessary network abstraction layer(NAL) is extracted by using information about a NAL unit according to an exemplary embodiment of the present invention;

FIG. 4 is a block-diagram illustrating an inner configuration of an MVC system according to an exemplary embodiment of the present invention;

FIG. 5 is a diagram illustrating a configuration of a bitstream;

FIG. 6 is a block-diagram illustrating an inner configuration of a decoding system according to an exemplary embodiment of the present invention; and

FIG. 7 is a block-diagram illustrating an inner configuration of a bitstream extraction system according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

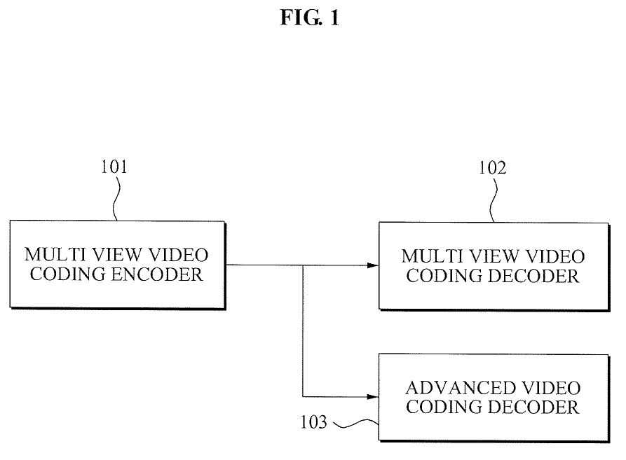

FIG. 1 is a diagram illustrating an application system in which a bitstream being coded through multi-view video coding (MVC) is inputted to a decoder as a single bitstream according to an exemplary embodiment of the present invention.

In the present specification, ‘advanced video coding (AVC)’ may denote a method for coding according to standards of AVC/H.264. In AVC/H.264, a network abstraction layer (NAL) is adopted to increase portability between networks. Through the adopting of the NAL, bitstreams in AVC/H.264 may be easily transmitted via various networks. That is, to freely use AVC/H.264 in various networks, in particular to easily transmit data between different networks, AVC/H.264 is divided into a layer functioning to compress a moving picture signal and a layer functioning to transform different information to a specific type that can be transmitted over a network. The layer functioning to compress the moving picture is referred to as a ‘video coding layer (VCL)’, and the layer functioning to transform the network is referred to as a ‘NAL’. In this instance, a bitstream or compressed data in a packet type may be transmitted via various types of networks, the transmitted data is re-configured in an NAL unit, that is an identical data type over all networks. Table 1 shows NAL unit type (hereinafter ‘nal_unit_type’) codes and definitions regarding the nal_unit_type codes in the standard of AVC/H.264. An NAL unit having nal_unit_type 1 through 5 is referred to as ‘VCL units’, and other units are referred to as ‘non-VCL’ units.

TABLE 1

| Nal_unit_type | Contents of NAL unit and structure of RBSP | C |
|---|---|---|
| 0 | Unspecified | |
| 1 | Coded slice of a non-IDR picture | 2, 3, 4 |
| | slice_layer_without _partitioning_rbsp( ) | |
| 2 | Coded slice data partition A | 2 |
| | slice_data_partition _a_layer_rbsp( ) | |
| 3 | Coded slice data partition B | 3 |
| | slice_data_partition _b_layer_rbsp( ) | |
| 4 | Coded slice data partition C | 4 |
| | slice_data_partition _c_layer_rbsp( ) | |
| 5 | Coded slice of an IDR picture | 2, 3 |
| | slice_layer_without _partitioning_rbsp( ) | |
| 6 | supplemental enhancement information (SEI) | 5 |
| | sei_rbsp( ) | |
| 7 | Sequence parameter set | 0 |
| | seq_parameter _set_rbsp( ) | |
| 8 | Picture parameter set | 1 |
| | pic_parameter _set_rbsp( ) | |
| 9 | Access unit delimiter | 6 |
| | access_unit_delimiter _rbsp( ) | |
| 10 | End of sequence | 7 |
| | end_of_seq_rbsp( ) | |
| 11 | End of stream | 8 |
| | end_of_stream_rbsp( ) | |
| 12 | Filter data | 9 |
| | filter_data_rbsp( ) | |
| 13 . . . 23 | Reserved | |
| 23 . . . 31 | Unspecified | |

Contents using MVC may be inputted to an advanced video coding decoder that decodes a video with a single view by a coded bitstream or to a MVC decoder that decodes all multi-view videos. In this instance, types of the bitstream may be classified into the following two cases:
1. A bitstream coded through MVC is inputted to a decoder as a single bitstream as a whole, that is there is no bitstream extractor.
2. A bitstream coded through MVC is inputted to a decoder as a bitstream whose necessary NAL is exclusively extracted using information about an NAL unit, that is there is a bitstream extractor.

FIG. 1 is an example of an application system in which a bitstream being coded through multi-view video coding (MVC) is inputted to a decoder as a single bitstream according to an exemplary embodiment of the present invention. That is, FIG. 1 illustrates the former case of the above-mentioned cases, and indicates that there is no bitstream extractor in an end of an MVC encoder 101, an MVC decoder 102, or in a front a beginning of the advanced video coding decoder 103. In this instance, the MVC decoder 102 may decode the inputted coded bitstream without problem.

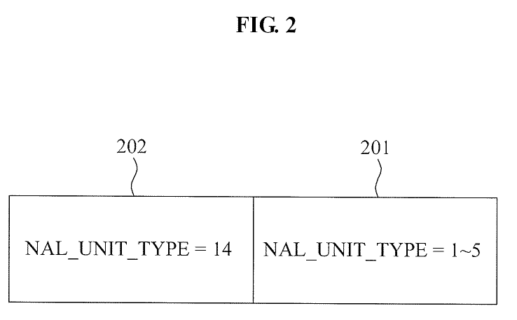

However, the advanced video coding decoder 103 can not decode a single view when a number of a base view is plural within the inputted coded bitstream. This is because a prefix NAL unit is prior to a coded slice unit with respect to the base view. FIG. 2 is an example of a coded slice unit. Referring to FIG. 2, in MVC, a prefix NAL unit of a ‘nal_unit_type=14’ 202 is prior to a coded slice unit of a base view being established to be a ‘nal_unit_type=1˜5’ 201. In this instance, the ‘nal_unit_type=14’ 202 may be specified to display a coded slice unit of a base view in MVC, which is coded via a reserved ‘nal_unit_type’, from among an identifier ‘nal_unit_type’ indicating types of the NAL unit, and may be exclusively established a ‘nal_unit_header_svc_mvc_extention( )’ structure.

In other words, when the prefix NAL unit is specified in the MVC encoder 101 as illustrated in FIG. 2, the ‘nal_unit_header_svc_mvc_extension( )’ structure specifying header information necessary for MVC is executed, and information of a view identifier ‘view_id’ is obtained in the coded slice unit of the base view followed by the prefix NAL unit. However, in the advanced video coding decoder 103, as shown in the 15 lines of Table 1, a view identifier with respect to the NAL unit being inputted after the prefix NAL unit is not obtained since the prefix NAL unit is not recognized, and the coded slice unit which is established as the ‘nal_unit_type=1˜5’ is decoded. In this instance, as described above, when the number of the base view is plural, since the coded slice unit being established as the ‘nal_unit_type=1˜5’ 201 is coded by referring to video signals of at least two views with each other, the advanced video coding decoder 103 cannot decode the bitstreams regularly. Therefore, the base view should be established as a single. However, an application having a plurality of views that should be independently decoded may exist.

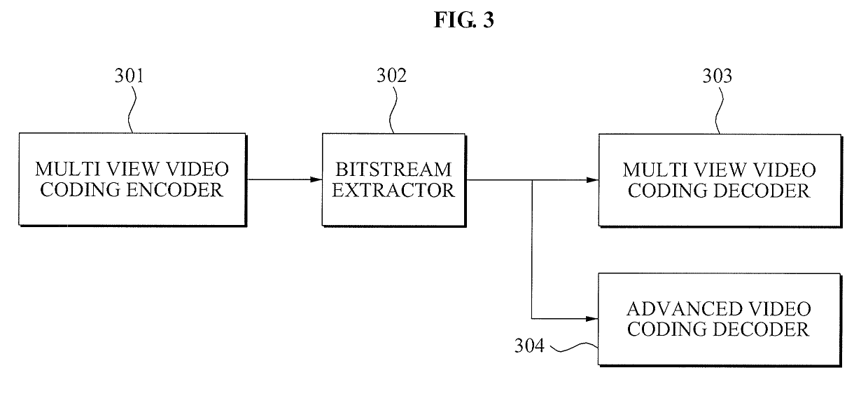

FIG. 3 is a diagram illustrating an application system in which a bitstream being coded through MVC is inputted to a decoder as a bitstream whose necessary NAL is extracted using by information about an NAL unit according to an exemplary embodiment of the present invention.

That is, FIG. 3 shows the later case of the above-mentioned cases, and illustrates that there is a bitstream extractor in an end of the MVC encoder 101 of FIG. 1, the MVC decoder 102 of FIG. 1, or in a beginning of the advance video coding decoder 103 of FIG. 1. In this instance, as illustrated above, from among bitstreams being coded in the MVC encoder 301, a bitstream with respect to a necessary NAL is extracted from a bitstream extractor 302 using information about the NAL unit, and the extracted bitstream is inputted to the MVC decoder 303 or to an advanced video coding decoder 304.

In this instance, the bitstream outputted from the MVC encoder 301 may be decoded without any problem when the bitstream outputted from the MVC encoder 301 is inputted to the MVC decoder 303, and, to support an application having a plurality of views that should be independently decoded in the advanced video coding decoder 304, the bitstream of a video signal being coded to the independent view should be extracted from the bitstream extractor 302 using information about the plurality of independents views, and the extracted bitstream should be inputted to the advanced video coding decoder 304.

Therefore, according to an embodiment of the present invention, backward compatibility with the advanced video coding is supported by adding a base view identifier of a base view to a expanded sequence parameter set for MVC. Also, similar to the base view, an application with a plurality of views can be supported by separately defining an independent view which is coded without referring to other views, and a view random access can be easily supported.

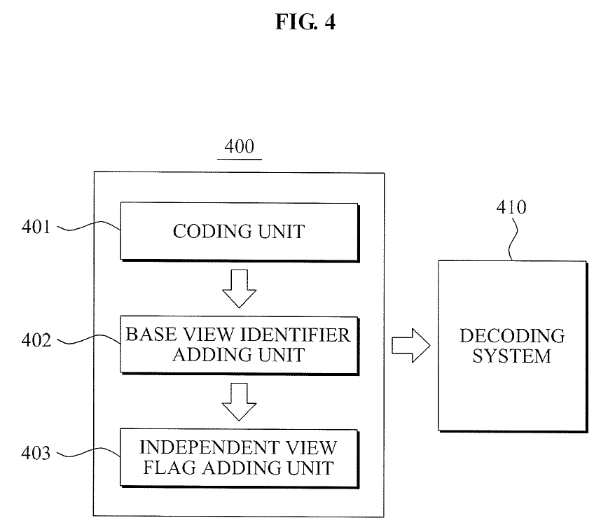

FIG. 4 is a block diagram illustrating an inner configuration of an MVC system 400 according to an exemplary embodiment of the present invention. The MVC system 400 according to the present invention codes a video signal having a picture taken via a plurality of cameras through MVC. In this instance, the MVC system 400 includes a coding unit 401, a base view identifier adding unit 402, and an independent view flag adding unit 403.

The coding unit 401 codes the video signal to a base view and a multi-view. In this instance, the base view may be limited to a single view of all views, and a video signal corresponding to the base view may be coded without referring to other views.

The base view identifier adding unit 402 adds a base view identifier of the base view to a parameter set. The parameter set may be transmitted to a decoding system 410 prior to the coded video signal. That is, the signal being coded to the base view may be verified in the decoding system 410 based on a base view identifier of the parameter set being transmitted prior to the coded signal. Specifically, the parameter set may be included in an NAL being transmitted prior to an NAL of a video signal which is actually coded when transmitting the coded signal.

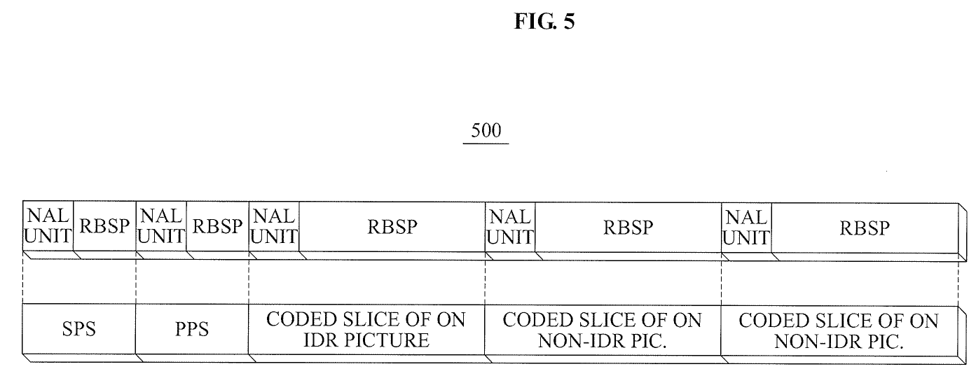

FIG. 5 is a diagram illustrating a configuration of a bitstream 500. Referring to FIG. 5, the bitstream 500 consists of five NALs, and each of five NALs consists of an NAL unit and a raw byte sequence payload (RBSP). In this instance, a sequence parameter set (SPS) and a parameter set informing a picture parameter set and the like, and slice data corresponding to a VCL may be included in the RBSP. Also, a view identifier of a corresponding video signal may be included in a header of the NAL unit.

That is, by adding the base view identifier to the parameter set such as the SPS which is transmitted prior to the NAL of an actually coded video signal in the base view identifier adding unit 402, after the decoding system 410 having received a subsequent bitstream obtains the base view identifier, the obtained base view identifier is compared with a view identifier of the header of the NAL unit, and the NAL of the coded video signal being coded to the base view may be verified.

Referring to Table 2, a base view identifier ‘base_view_id’ of a base view, limited to a single view, is specified in a structure ‘seq_parameter_set_mvc_extension( )’, from among joint multi-view video model (JMVM) structures specified in a moving picture experts group (MPEG) and joint video team (JVT) as shown in the first three lines in Table 2. Specifically, as illustrated in FIG. 2, it is possible to decode a bitstream of a video signal being coded to the base view via the base view identifier in an existing advanced video coding decoder without parsing all view dependency information. That is, backward compatibility between MVC and advanced video coding can be effectively provided.

TABLE 2

| Seq_parameter_set_mvc_extension( ){ | C | Descriptor |
|---|---|---|
| mum_views_minus_1 | | ue(v) |
| base_view_id | | ue(v) |
| for(i = 0; i <= num_views_minus_1; i++) | | |
| view_id[i] | | ue(v) |
| for(i = 0; I <= num_views_minus_1; i++){ | | |
| num_anchor_refs_l0[i] | | ue(v) |
| for(j = 0; j <= num_anchor_refs_l0[i]; j++) | | |
| anchor_ref_l0[i][j] | | ue(v) |
| num_anchor_refs_l1[i] | | ue(v) |
| for(j = 0; j <= num_anchor_refs_l1[i]; j++) | | |
| anchor_ref_l0[i][j] | | ue(v) |
| } | | |
| for(i = 0; I <= num_views_minus_1; i++){ | | |
| num_non_anchor_refs_l0[i] | | ue(v) |
| for(j = 0; j <= num_{—} non_anchor_refs_l0[i]; j++) | | |
| non_anchor_ref_l0[i][j] | | ue(v) |
| num_{—} non_anchor_refs_l1[i] | | ue(v) |
| for(j = 0; j <= num_{—} non_anchor_refs_l1[i]; j++) | | |
| non_anchor_ref_l1[i][j] | | ue(v) |
| } | | |
| } | | |

In Table 2, ‘num_views_minus_{—}1’ may indicate a number that is one less than a whole number of a view which is coded in the bitstream. As an example, ‘num_views_minus_{—}1’ may indicate a number within a range of 0 to 1023.

In Table 2, a ‘base_view_id’ may indicate a ‘view_id’ of the base view, and the ‘view_id[i]’ may indicate a ‘view_id’ of a view having coding orders which is instructed by a variable i.

In Table 2, a ‘num_anchor_refs_{—}10[i]’ may indicate a possible inter-view prediction reference number for ‘RefPicList( )’, and ‘RefPicList( )’ may indicate a structure used for an anchor picture having an identical ‘view_id’ as the ‘view_id[i]’. In this instance, the ‘num_anchor_refs_{—}10[i]’ may be equal to or less than a ‘num_ref_frames’ of a number of a reference frame.

In Table 2, ‘ue(v)’ may indicate an Exp-Golomb code in a positive number type.

Also, the coding unit 401 may further code the video signal to an independent view, in this instance, the independent view flag adding unit 403 of FIG. 4 adds an independent view flag of the independent view to the header of the NAL unit. In this instance, the video signal being coded to the independent view may be coded without referring to other views. This is because an application having a plurality of views that should be independently decoded exists, and a view random access should be supported with respect to the application.

Table 3 illustrates a structure ‘nal_unit_header_svc_mvc_extension( )’ of a JMVM specified in MPEG and JVT, and illustrates an example that an independent view flag is added by changing the structure ‘nal_unit_header_svc_mvc_extension( )’. Table 4 illustrates an example that the independent view flag is added to header information in the MVC system 400 according to the present invention.

TABLE 3

| Nal_unit_header_svc_mvc_extension( ){ | C | Descriptor |
|---|---|---|
| svc_mvc_flag | All | u(1) |
| if(!svc_mvc_flag){ | | |
| idr_flag | All | u(1) |
| priority_id | All | u(6) |
| temporal_id | All | u(3) |
| dependency_id | All | u(3) |
| quality_id | All | u(2) |
| layer_base_flag | All | u(1) |
| use_base_prediction_flag | All | u(1) |
| discardable_flag | All | u(1) |
| output_flag | All | u(1) |
| reserved_zero_four_bits | All | u(3) |
| }else{ | | |
| priority_id | All | u(6) |
| temporal_id | All | u(3) |
| anchor_pic_flag | All | u(1) |
| view_id | All | u(10) |
| idr_flag | All | u(1) |
| inter_view_flag | All | u(1) |
| reserved_zero_one_bit | All | u(1) |
| } | | |
| nalUnitHeaderBytes += 3 | | |
| } | | |

TABLE 4

| Nal_unit_header_svc_mvc_extension( ){ | C | Descriptor |
|---|---|---|
| svc_mvc_flag | All | u(1) |
| if(!svc_mvc_flag){ | | |
| idr_flag | All | u(1) |
| priority_id | All | u(6) |
| temporal_id | All | u(3) |
| dependency_id | All | u(3) |
| quality_id | All | u(2) |
| layer_base_flag | All | u(1) |
| use_base_prediction_flag | All | u(1) |
| discardable_flag | All | u(1) |
| output_flag | All | u(1) |
| reserved_zero_four_bits | All | u(3) |
| nalUnitHeaderBytes += 3 | | |
| }else{ | | |
| priority_id | All | u(6) |
| temporal_id | All | u(3) |
| inter_view_flag | All | u(1) |
| if(nal_unit_type == 20){ | | |
| anchor_pic_flag | All | u(1) |
| view_id | All | u(10) |
| idr_flag | All | u(1) |
| independent_view_flag | All | u(1) |
| nalUnitHeaderBytes += 3 | | |
| }else{ | | |
| reserved_zero_five_bits | All | u(5) |
| nalUnitHeaderBytes += 2 | | |
| } | | |
| } | | |
| } | | |

In Tables 3 and 4, a ‘priority_id’ may indicate a priority identifier for the NAL unit. As a value of the ‘priority_id’ is smaller, a priority of the NAL unit may have a higher priority. When the NAL unit is a prefix NAL unit, the priority identifier may be applied to a joint NAL unit immediately followed by the prefix NAL unit in an order of decoding. If a possible predetermined value of the ‘priority_id’ is ‘pid’, a bitstream that can be obtained by discarding all VCL NAL units having higher ‘priority_id’ than the ‘pid’ as well as a non-VCL NAL unit and a supplemental enhancement information (SEI) message may based on a recommended international standard.

In Tables 3 and 4, a ‘temporal_id’ may indicate a temporary scalable level of the NAL unit. When a ‘temporal_id’ does not exist for a single NAL, a value of the ‘temporal_id’ may be estimated as a value of a ‘temporal_id’ of a joint prefix network layer.

In Tables 3 and 4, an ‘inter_view_flag’ may indicates that when *an ‘inter_view_flag’ is a value of 0, a picture being coded in a present NAL unit is not used for inter-view prediction, and when the *‘inter_view_flag’ is a value of 1, the coded picture is not used for the inter-view prediction.

In Tables 3 and 4, a ‘reserved_zero_one_bit’ and a ‘reserved_zero_five_bit’ are a value of ‘0’. The other values of the ‘reserved_zero_one_bit’ and ‘reserved_zero_five_bit’ may be specified in the future by ITU-T|ISO/IEC.

A decoder may discard values of the ‘reserved_zero_one_bit’ and the ‘reserved_zero_five_bit’.

When a base view is limited to a single view, as illustrated in Table 3, since an ‘anchor_pic_flag(1 bit)’, a ‘view_id(10 bit)’, and an ‘idr_flag(1 bit)’ specified in an existing structure ‘nal_unit_header_svc_mvc_extension( )’ are values that can be understood by a value of a ‘nal_unit_type’ indicating a type of an NAL unit, a coding bit can be reduced by changing as illustrated in Table 4.

That is, information about the ‘anchor_pic_flag(1 bit)’ can be obtained by a ‘slice_type’ indicating a slice type in an NAL being established to be a ‘nal_unit_type=1˜5’ based on a prefix NAL unit being established to be a ‘nal_unit_type=14’. As an example, when values of the ‘slice_type’ are 2, 4, 7, and 9, a value of the ‘anchor_pic_flag’ is 1, otherwise a value of the ‘anchor_pic_flag’ is 0.

Also, when a ‘sequence_parameter_set_mvc_extension( )’ structure includes information for a base view identifier in the base view, it is easily understood that a corresponding NAL corresponds to the base view, via a header of the NAL unit being established to be the ‘nal_unit_type=1˜5’. Therefore, the prefix NAL unit does not require the information for the base view identifier.

Further to this, the ‘idr_flag(1 bit)’ may be understood by the ‘nal_unit_type’ based on the ‘nal_unit_type=14’. As an example, when the ‘nal_unit_type=5’, a slice is an instantaneous decoding refresh (IDR) picture, otherwise the slice is a non-IDR picture.

An NAL unit being independently coded without inter-view prediction may be established as a ‘nal_unit_type=20’ of reserved ‘nal_unit_types’, and, in this instance, whether a view is an independent view or not is verified by checking a header of the NAL unit. An NAL unit being coded to a base view may be established to as the ‘nal_unit_type=1˜5’. Therefore, the header of the NAL unit may include an independent flag to verify whether a view is an independent view as illustrated in Table 3. In this instance, the independent flag may be represented as an ‘independent_view_flag’ as illustrated in Table 4. A bitstream extraction unit according to the present invention can easily manage to process a specific independent view in header information such as the structure ‘nal_unit_header_svc_mvc_extention( )’ without parsing whole view dependency information.

Also, the independent view flag is useful to find an independent view when a type of an NAL unit is a ‘nal_unit_type=20’. Specifically, when the type of the NAL unit is a ‘nal_unit_type=20’, and when a single view in a base view is required to be decoded, in the bitstream extraction system, a corresponding view may be decoded to be identical to a base view in a decoding system such as the advanced video coding decoder by re-establishing the ‘nal_unit_type=20’ as the ‘nal_unit_type=1˜5’ based on the independent view flag, the ‘idr_flag’, and a view identifier.

‘u(n)’ in Table 4 may indicate a positive number type having an n-bit without a sign.

Table 5 illustrates an existing ‘nal_unit( )’ structure from among the JMVM structure specified in the MPEG and JVT, and Table 6 illustrates a structure, which changes the existing ‘nal_unit()’, as a result of reducing a coding bit by changing as illustrated in FIG. 4.

TABLE 5

| nal_unit(NumBytesInNALunit){ | C | Descriptor |
|---|---|---|
| forbidden_zero_bit | All | f(1) |
| nal_ref_idc | All | u(2) |
| nal_unit_type | All | u(5) |
| nalUnitHeaderBytes = 1 | | |
| if(nal_unit_type == 14 \|\| nal_unit_type == 20){ | | |
| nal_unit_header_svc_mvc_extension( ) | | |
| nalUnitHeaderBytes += 3 | | |
| } | | |
| NumBytesInRBSP = 0 | | |
| for(I = nalUnitHeaderBytes; i < NumBytesInNALunit; i++){ | | |
| if(i+2 < NumBytesInNALunit && next_bits(24) == 0x000003){ | | |
| rbsp_byte[ NumBytesInRBSP++] | All | b(8) |
| rbsp_byte[ NumBytesInRBSP++] | All | b(8) |
| i += 2 | | |
| emulation_prevention_three_byte /* equal to 0x03 */ | All | f(8) |
| }else | | |
| rbsp_byte[ NumBytesInRBSP++] | All | b(8) |
| } | | |
| } | | |

TABLE 6

| nal_unit(NumBytesInNALunit){ | C | Descriptor |
|---|---|---|
| forbidden_zero_bit | All | f(1) |
| nal_ref_idc | All | u(2) |
| nal_unit_type | All | u(5) |
| nalUnitHeaderBytes = 1 | | |
| if(nal_unit_type == 14 \|\| nal_unit_type == 20){ | | |
| nal_unit_header_svc_mvc_extension( ) | | |
| if(nal_unit_type == 14) | | |
| nalUnitHeaderBytes += 2 | | |
| else | | |
| nalUnitHeaderBytes += 3 | | |
| } | | |
| NumBytesInRBSP = 0 | | |
| for(I = nalUnitHeaderBytes; i < NumBytesInNALunit; i++){ | | |
| if(i+2 < NumBytesInNALunit && next_bits(24) == 0x000003){ | | |
| rbsp_byte[ NumBytesInRBSP++] | All | b(8) |
| rbsp_byte[ NumBytesInRBSP++] | All | b(8) |
| i += 2 | | |
| emulation_prevention_three_byte /* equal to 0x03 */ | All | f(8) |
| }else | | |
| rbsp_byte[ NumBytesInRBSP++] | All | b(8) |
| } | | |
| } | | |

Referring to Tables 5 and 6, ‘f(n)’ may indicate data of a fixed pattern having an n-bit, and the ‘b(8)’ may indicate data of a byte type having an 8-bit.

The MVC coding system 400 of FIG. 4 may further include a bitstream generation unit that generates a bitstream including at least two of a first NAL with respect to the parameter set and a second NAL with respect to the coded video signal. The generated bitstream may be directly transmitted to the decoding system 410 of FIG. 4 according to the present invention, or may be transmitted to the decoding system 410 via a bitstream extraction system (not shown). In this instance, the first NAL may be transmitted prior to the second NAL.

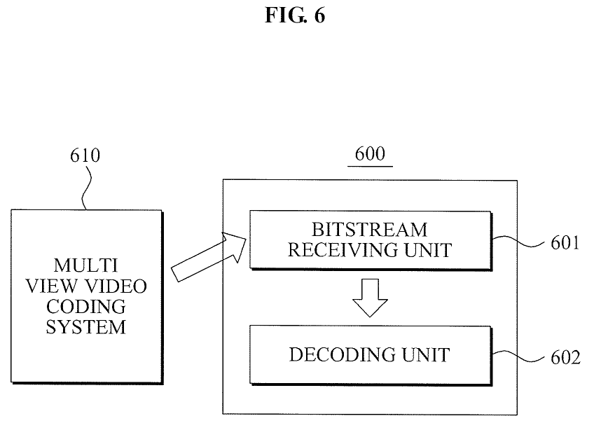

FIG. 6 is a block-diagram illustrating an inner configuration of a decoding system 600 according to an exemplary embodiment of the present invention. As illustrated in FIG. 6, the decoding system 600 may include a bitstream receiving unit 601 and decoding unit 602.

The bitstream unit 601 receives a bitstream of a coded signal. The received bitstream may include a single bitstream, from among a bitstream whose necessary NAL is extracted using information about all bitstreams with respect to the coded signal and the NAL unit, which are initially transmitted from a MVC system 610. Also, the received bitstream may include an NAL including an NAL unit.

The decoding unit 602 decodes a corresponding bitstream to a base view based on a parameter set included in the received bitstream. In this instance, the bitstream with respect to the parameter set may be received prior to a bitstream of the coded video signal. The parameter set may include a base view identifier of the coded video signal being coded to the base view. In this instance, the decoding unit 602 may verify and decode a video signal being coded to the base view, from among the video signals being coded via a base view identifier in the bitstream. That is, the bitstream of the video signal being coded to the base view may be easily verified and decoded via the base view identifier included in the parameter set.

Also, the decoding unit 692 may verify a video signal in the bitstream being coded to an independent view included in a header of the NAL unit based on an independent view flag included in the header of the NAL unit, and may selectively decode verified signal. That is, the base view is established to be a single, however an application having a plurality of views that should be independently decoded, an independent view being coded without referring to other views is verified via the independent view flag, the application can be supported and a view random access can be supported.

Therefore, even when the decoding system 600 uses an advanced video coding, coded contents through MVC may be decoded again. Also, since the independent view is not limited to a number of views when coding, the application having the plurality of views that should be independently decoded can be supported and a view random access may be easier.

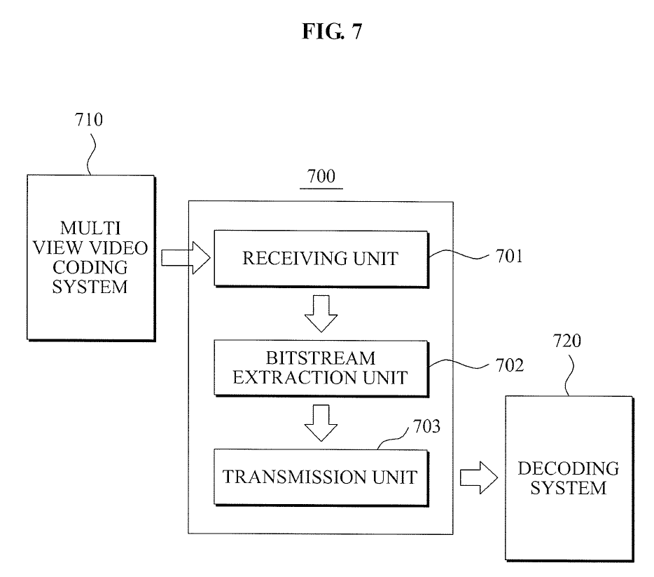

FIG. 7 is a block-diagram illustrating an inner configuration of a bitstream extraction system 700 according to an exemplary embodiment of the present invention. As illustrated in FIG. 7, the bitstream extraction system 700 includes a receiving unit 701, a bitstream extraction unit 702, and a transmission unit 703.

The receiving unit 701 receives a bitstream being coded from the MVC coding system 710. In this instance, the coded bitstream may include at least one NAL.

The bitstream extraction unit 702 extracts at least one portion of the bitstream based on at least one of a parameter set and a header of an NAL unit. The parameter set may be included in an NAL being transmitted prior to an NAL of a video signal which is actually coded. Also, the parameter set may include a base view identifier of the video signal being coded to the base view based on the base view identifier, in this instance the bitstream extraction unit 702 may extract a bitstream of the coded video signal being coded to the base view. Further to this, the header may include an independent flag of the video signal being coded to the independent view, and the independent view flag may indicate whether the coded video signal corresponding to the NAL units is an independent view or not. In this instance, the bitstream extraction unit 702 may extract a bitstream of the video signal being coded to the independent view based on the independent view flag.

The transmission unit 703 transmits the extracted at least one portion of the bitstream to a corresponding decoding system 720. Specifically, since the decoding system 720 receives the base view or independent view being independently coded, even when the decoding system 720 is the advanced video decoding system, the bitstream being coded to the base view may be decoded normally, an application having a plurality of views that should be independently decoded may be easily supported, and a view random access may be easily supported.

The bitstream extraction unit 700 may further include a type change unit (not shown) that changes a type of the NAL unit of the coded video signal being coded to the independent view. That is, the video signal being coded to the independent view in the decoding system 720 may be decoded as identical to the coded signal being coded to the base view by changing a type of the NAL unit with respect to the coded signal being coded to the independent view to a type of the NAL unit with respect to the coded video signal to the base view.

According to the present invention, it is possible to decode, in a decoder, an image being coded to a base view in multi-view video coding for providing backward compatibility.

According to the present invention, it is possible to support an application having a plurality of views that should be independently decoded by separately defining an independent view being coded without referring to other views, and to easily support a view random access.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multi-view video coding system that codes a video signal of a picture taken via a plurality of cameras, the system comprising:
a coding unit that codes the video signal to a base view and a multi-view; and
a base view identifier adding unit that adds a base view identifier of the base view to a parameter set.

2. The system of claim 1, wherein the parameter set is transmitted to a decoding system prior to the coded video signal.

3. The system of claim 2, wherein the coded video signal being coded to the base view is verified based on the base view identifier of the parameter set which is transmitted prior to the coded video signal.

4. The system of claim 1, wherein the parameter set is included in a network abstraction layer (NAL) being transmitted prior to an NAL of a video signal which is actually coded when transmitting the coded video signal.

5. The system of claim 4, wherein the parameter set comprises a sequence parameter set (SPS), and the SPS is an NAL which is transmitted first when transmitting a video stream of the coded video signal.

6. The system of claim 1, wherein the coding unit further codes the video signal to an independent view, and further comprises an independent view flag adding unit adding the independent view flag of the independent view to a header of an NAL unit.

7. The system of claim 6, wherein the coded video signal being coded to the independent view is coded without referring to other views.

8. The system of claim 6, wherein the independent view flag indicates whether the video signal corresponding to the NAL unit is an independent view.

9. The system of claim 1, wherein the base view is limited to a single view of all views.

10. The system of claim 1, further comprising:
a bitstream generation unit that generates a bitstream including at least two of a first NAL with respect to the parameter set and a second NAL with respect to the coded video signal, and
wherein the first NAL is transmitted to prior to the second NAL.

11. A decoding system that decodes a coded video signal being coded through multi-view video coding, the system comprising:
a bitstream receiving unit that receives a bitstream of the coded video signal; and
a decoding unit that decodes a bitstream corresponding to a base view based on a parameter set included in the received bitstream.

12. The system of claim 11, wherein the bitstream of the parameter set is received prior to the bitstream of the coded video signal.

13. The system of claim 11, wherein the parameter set comprises a base view identifier of the coded video signal being coded to the base view, and the decoding unit decodes the video signal being coded to the base view, from among the video signals being coded via the base view identifier in the bitstream.

14. The system of claim 11, wherein the received bitstream comprises a network abstraction layer (NAL) including an NAL unit, and the decoding unit decodes a video signal being coded to an independent view, from among the code video signals being coded based on an independent view flag included in a header of the NAL unit, in the bitstream.

15. The system of claim 11, wherein the received bitstream comprises a single bitstream, from among bitstreams whose necessary NAL is extracted using information about whole bitstreams with respect to the coded signal and the NAL unit.

16. A bitstream extraction system, the system comprising:
a receiving unit that receives a bitstream from a multi-view video coding system;
a bitstream extraction unit that extracts at least one portion of the bitstream based on at least one of a parameter set and a header of a network abstraction layer (NAL) unit; and
a transmission unit that transmits the extracted at least one portion of the bitstream.

17. The system of claim 16, wherein the coded bitstream comprises at least one NAL, and the parameter set is included in an NAL being transmitted prior to an NAL of a video signal which is actually coded.

18. The system of claim 16, wherein the parameter set comprises a base view identifier of the coded video signal being coded to the base view, and the bitstream unit extracts a bitstream of the coded video signal being coded to the base view based on the base view identifier.

19. The system of claim 16, wherein the header comprises an independent view flag of the coded video signal being coded to the independent view, and the independent view flag indicates whether the coded video signal corresponding to the NAL unit is an independent view.

20. The system of claim 19, wherein the bitstream extractor extracts the bitstream of the coded video signal being coded to the independent view based on the independent view flag.

21. The system of claim 19, wherein a type change unit changes a type of the NAL unit of the coded video signal being coded to the independent view.
